(19) United States
(12) Patent Application Publication
(10) Pub. No.: US 2003/0010836 A1
(43) Pub. Date: Jan. 16, 2003

(54) Laminar device for fountains

(76) Inventor: Long Pham, Westminster, CA (US)

Correspondence Address: PHM, LONG, 9482 BEVAN AVE, WESTMINSTER, CA, 92683, US

(21) Appl. No.: 09/905,477

(22) Filed: Jul. 16, 2001

(51) Int. Cl. B05B 17/08

(52) U.S. Cl. 239/17; 239/590; 239/553.3; 239/590.3

(57) ABSTRACT

The main use of the laminar device is for fountain displays. When water flows though the surge suppressor assembly and laminar assembly, this device remove all the turbulent in fluid flow, and display an extreme laminar stream of water.

The laminar device consists of two assemblies: surge suppressor assembly and laminar assembly. The surge suppressor assembly is however not needed if the supply water system does not have a lot of pressure spikes. A surge suppressor will remove the pressure spikes in the water system. The surge suppressor is an air/water chamber. In that air/water chamber, the compressible air will either compress or expand accordingly to the line water pressure and absorb the water pressure spikes.

The laminar assembly is a large diameter tank that contains three major components. The first component is a turbulent remover that will remove the turbulent in the fluid and create an even fluid flow. The turbulent remover is a membrane with numerous 50 microns diameter holes. This perforated membrane will have an open area large enough to prevent substantial pressure drop. The second component is a flow anti-rotation device that will prevent fluid flow to rotate. This device consists of numerous ⅛″ diameter tubes of 1″-3″ length. The last component is orifice plate. The orifice plate with a machined tapered-out hole will help in produce a clean and smooth water stream since this configuration will prevent water turbulent at the hole edge.

### BACKGROUND OF THE INVENTION

1. Field of the Invention

The present invention relates to the field of water nozzle devices for water fountains.

2. Prior Art

This invention is using a turbulent remover that is neither taught nor suggested by the prior art. The turbulent remover is a membrane with numerous extremely small holes. The holes diameter is around 50 micron. When the water flows through, turbulent flows will be broken into million and million tiny flows that move slowly in the water tank. This perforated membrane will have an open area large enough to prevent substantial pressure drop.

The laminar flow of liquid could be determined by the Reynolds number. The Reynolds number is the ratio of the inertia force of a fluid stream to the viscous force.

Re=(U*D)/ν

Where

Re: Reynolds number

U: Flow velocity

D: Diameter of pipe

ν: Viscous force

When the Reynolds number is less than 2000, flow is in the laminar region. When Reynolds is larger than 2000 and less than 4000, flow is in transition. When Reynolds number is larger than 4000, flow is turbulent. Studying the formula, we could see that to obtain the low Reynolds number, U and D have to be small numbers and ν has to be large.

The turbulent remover in this invention lowers both U and D at the same time. It has a very large open area; therefore, the flow velocity is small. The remover consists of numerous small holes, which have small diameters (D).

### BRIEF SUMMARY OF THE INVENTION

The laminar device consists of two assemblies: surge suppressor assembly and laminar assembly. When water flows though the surge suppressor assembly and laminar assembly, this device remove all the turbulent in fluid flow, and display an extreme laminar stream of water.

The surge suppressor assembly is not needed if the supply water system does not have a lot of pressure spikes. A surge suppressor will remove the pressure spikes in the water system. The surge suppressor is an air/water chamber. In that air/water chamber, the compressible air will either compress or expand accordingly to the line water pressure and absorb the water pressure spikes.

The laminar assembly is a large diameter tank that contains three major components. The first component is a turbulent remover that will remove the turbulent in the fluid and create an even fluid flow. The turbulent remover is a simply perforated membrane with 50 microns diameter holes. This perforated membrane will have an open area large enough to slow water flow velocity and prevent substantial pressure drop. The second component is a flow anti-rotation device that will prevent fluid flow to rotate. This device consists of numerous ⅛″ diameter tubes of 1″-3″ length. The last component is orifice plate. The orifice plate with a machined tapered-out hole will help in produce a clean and smooth water stream since this configuration will prevent water turbulent generated at the hole edge.

### BRIEF DESCRIPTION OF THE DRAWINGS

FIG. 1 is a sectional view that shows water flow inside the surge suppressor assembly.

FIG. 2 is a sectional view that shows water flow inside the laminar assembly.

FIG. 3 is a sectional view and top view of the turbulent remover.

FIG. 4 is a side view and top view of the flow anti-rotational device.

FIG. 5 is a sectional view and top view of the orifice plate.

### DETAILED DESCRIPTION OF THE INVENTION

The main use of the laminar device is for fountain displays.

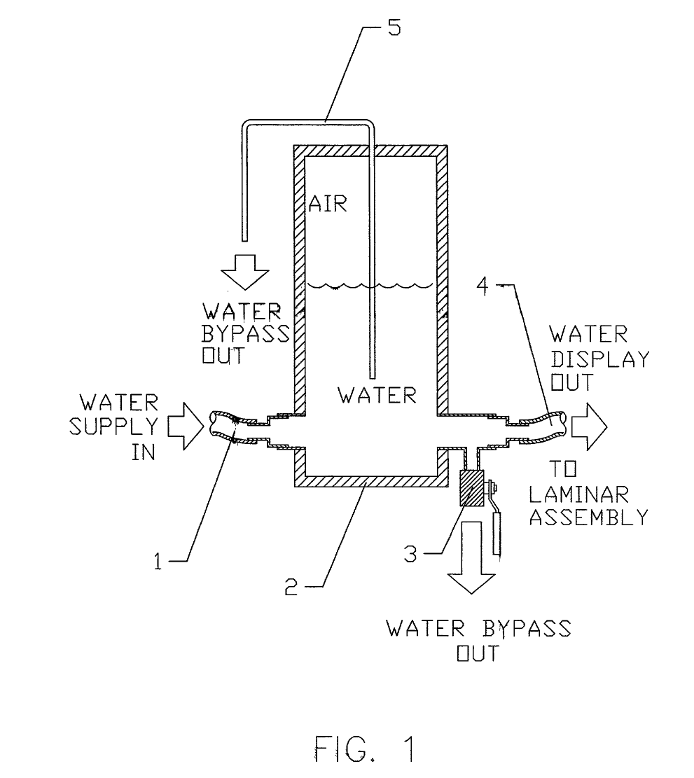

First referring to FIG. 1, the surge suppressor is comprised of an air and water tank (2) with water inlet and outlet near bottom. The air/water tank (2) could be simply a large diameter PVC pipe, around 4″ in diameter and 4 feet in length. There is a small tube (5) connecting through the air/water tank (2) at the top. The small tube (5), which could be copper tubing goes inside the air/water tank (2) and extends about 9″ from the tank bottom.

At first, the air/water tank (2) fills with air. The slightly open valve (3) will drain all the water out of the air/water tank (2) if there is any. When the hose (1) is connected to a water supply of at least 12 gpm at 50 ft of head, water will compress the air inside the air/water tank (2) into smaller volume. Some water will bypass out at the small tube (5) and at the slightly open valve (3). However, the majority of water will go out through the hose (4), since tube (5) has a small diameter of 1/16″ and valve (3) is just slight cracked open.

Now any water pressure spikes in the water line will be absorbed by the compressed air inside the air/water tank since air is compressible and will either expand or compress accordingly to the line water pressure.

The valve (3) will control how much water flows through the hose (4), by diverting water out. The purpose of the tube (5) is to prevent the air pocket getting too large. Quite often, air bubbles are trapped in the water line. Once the water gets in the air/water tank (2), the water velocity become much slower. As a result, air bubbles are detached from water and join the air pocket. With the bypass tube (5), once air pocket gets bigger to the end of tube (5), air will be carried out through tube (5). The hose (4) should be of elastic material and around of 20 ft length so that it could function as a shock absorber.

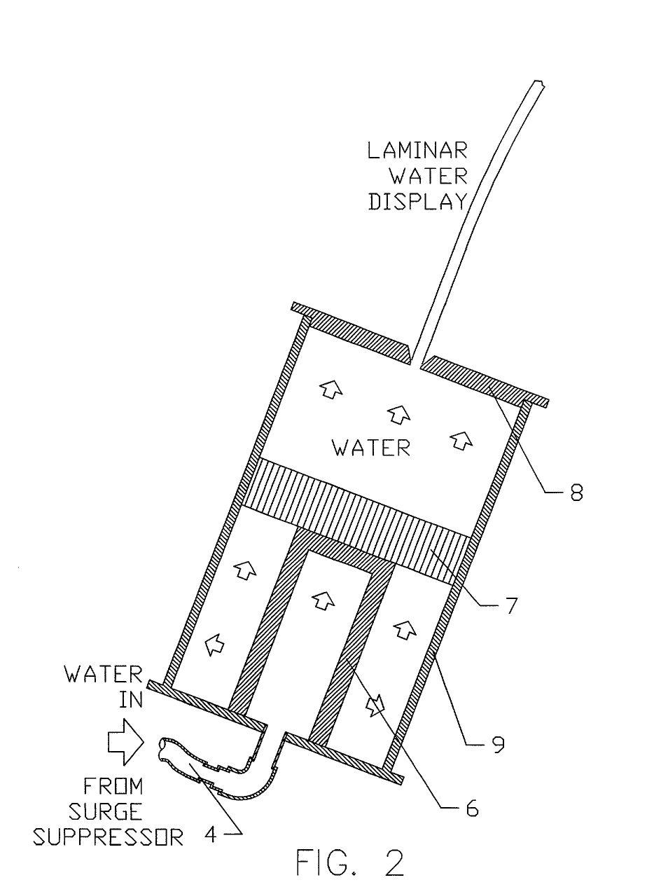

The hose (4) is connected to the laminar assembly (9) water inlet. Please refer to FIG. 2. The laminar assembly (9) is a large diameter water tank. The diameter is around from 8″ to 12″. The laminar assembly contains three major components: a turbulent remover (6), a flow anti-rotation device (7) and an orifice plate (8).

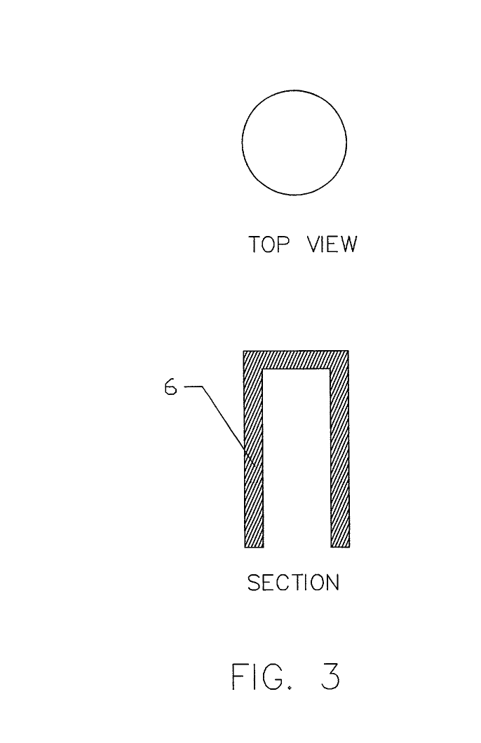

Please refer to FIG. 2 and FIG. 3. Water will enter through the turbulent remover (6) first. The turbulent remover (6) is a cylinder shaped thick membrane with numerous extremely small holes. The holes diameter is around 50 micron. The turbulent is located right at the center of the laminar assembly (9). When the water flows through, turbulent flows will be broken into million and million tiny flows that move slowly and even in the water tank. This perforated membrane will have an open area large enough to prevent substantial pressure drop, and slow the flow velocity.

Since the water tank is of large diameter, water velocity in the tank is quite slow. The slow velocity also helps in creating laminar flow.

The laminar flow of liquid could be determined by the Reynolds number. The Reynolds number is the ratio of the inertia force of a fluid stream to the viscous force.

Re=(U*D)/ν

Where

Re: Reynolds number

U: Flow velocity

D: Diameter of pipe

ν: Viscous force

When the Reynolds number is less than 2000, flow is in the laminar region. When Reynolds is larger than 2000 and less than 4000, flow is in transition. When Reynolds number is larger than 4000, flow is turbulent. Studying the formula, we could see that to obtain the low Reynolds number, U and D have to be small numbers and ν has to be large.

The turbulent remover in this invention lowers both U and D at the same time. It has a very large open area; therefore, the flow velocity is small. The remover consists of numerous small holes, which have small diameters (D).

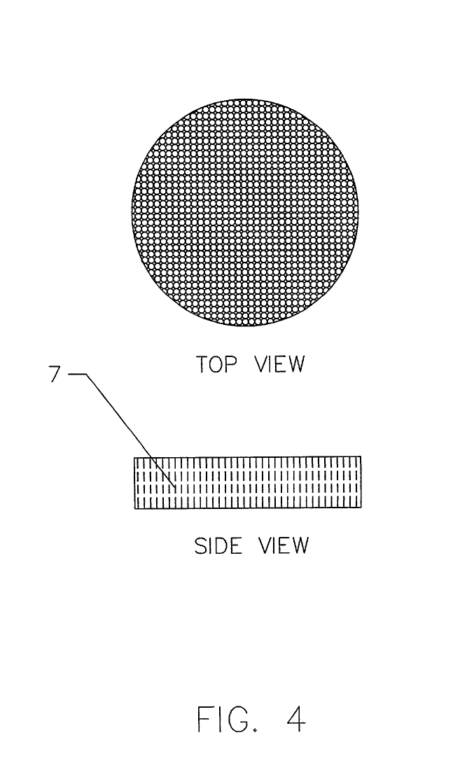

Please refer to FIG. 2 and FIG. 4. After water flows through the turbulent remover, the flow is free of turbulent, but it tends to rotates slightly. The flow anti-rotation device (7) stops the flow rotation. The flow anti-rotation device consists of numerous small tubes. These tubes are of ⅛″ in diameter, and of 1-3″ length. When water flows into this device, flows again are broken into numerous small flows. When the water travels in the ⅛″ tubes, water is kept from rotating around the laminar assembly (9). The tubes keep water flowing straight.

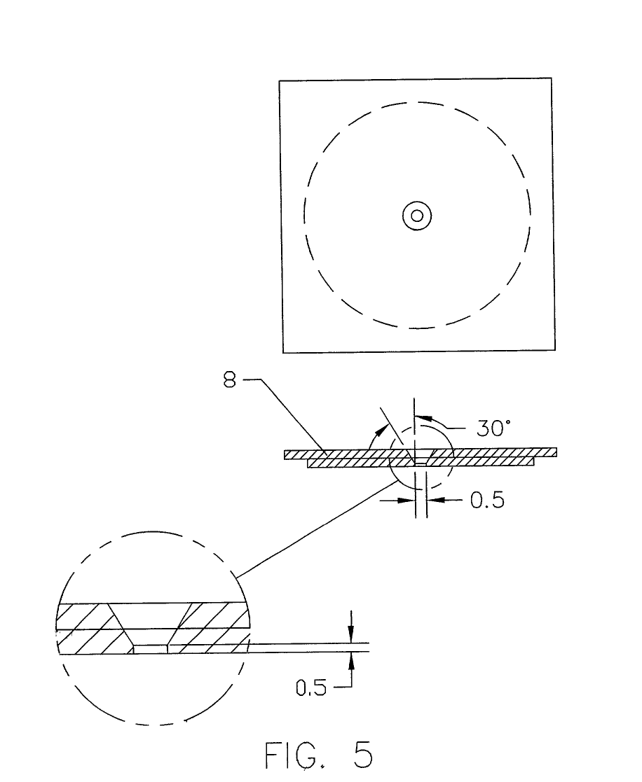

Please refer to FIG. 2 and FIG. 5. The last component is the orifice plate (8). The orifice plate with a machined tapered-out hole will help in producing a clean and smooth water stream since this configuration will prevent water turbulent at the hole edge. The hole diameter is from ½″ to ¾″. Notice that the sharp edge will provide quick detach of water from the nozzle. The hole must be machined so that it is extremely smooth and even.

I claim:

1. The laminar assembly is a large diameter tank that contains three major components: a turbulent remover, a flow anti-rotation means and an orifice plate.

2. The laminar assembly of claim 1 wherein said turbulent remover is a membrane with numerous extremely small holes.

3. The laminar assembly of claim 1 wherein said flow anti-rotation means consists of numerous small parallel tubes.
